(19) United States
(12) Patent Application Publication
(10) Pub. No.: US 2014/0355469 A1
(43) Pub. Date: Dec. 4, 2014

(54) METHOD AND APPARATUS FOR MEASURING INTERFERENCE IN A WIRELESS COMMUNICATION SYSTEM

(71) Applicant: LG ELECTRONICS INC., Seoul (KR)

(72) Inventors: Ji Won Kang, Anyang-si (KR); Jin Young Chun, Anyang-si (KR); Ki Tae Kim, Anyang-si (KR); Su Nam Kim, Anyang-si (KR); Bin Chul Ihm, Anyang-si (KR); Sung Ho Park, Anyang-si (KR)

(73) Assignee: LG ELECTRONICS INC., Seoul (KR)

(21) Appl. No.: 14/361,236

(22) PCT Filed: Dec. 7, 2012
(86) PCT No.: PCT/KR2012/010614

§ 371 Date: May 28, 2014

Related U.S. Application Data
(60) Provisional application No. 61/567,638, filed on Dec. 7, 2011.

(51) Int. Cl. H04W 24/08; H04W 72/04; H04W 72/08; H04L 5/00

(52) U.S. Cl. CPC H04W 24/08; H04L 5/0053; H04W 72/0413; H04W 72/082; H04L 5/0051
USPC 370/252

(57) ABSTRACT

Provided are a method for measuring the interference of user equipment (UE) in a wireless communication system, and user equipment using the method. The method involves receiving an indication of a reference resource and an amount of interference correction from a base station, measuring an amount of interference in the reference resource, and correcting the measured amount of interference on the basis of the instructed amount of interference. The user equipment feeds back the corrected amount of interference and/or channel state information generated on the basis of the corrected amount of interference to the base station.

### BACKGROUND OF THE INVENTION

1. Field of the Invention

The present invention relates to a wireless communication, more particularly, to a method and an apparatus for measuring interference in a wireless communication system.

2. Related Art

The next-generation multimedia wireless communication systems now being actively researched are required to process and send various pieces of information, such as video and wireless data out of the early voice-centered service. The 4^{th} generation wireless communication systems being developed which are subsequent to the current 3^{rd} generation wireless communication systems are aiming at supporting high-speed data service of downlink 1 Gigabit per second (Gbps) and of uplink 500 Megabits per second (Mbps). An object of a wireless communication system is to enable a number of users to perform reliable communication irrespective of their locations and mobility. However, a wireless channel has abnormal characteristics, such as a path loss, noise, a fading phenomenon attributable to multi-path, Inter-Symbol Interference (ISI), and the Doppler effect resulting from the mobility of a terminal. A variety of techniques are being developed in order to overcome the abnormal characteristics of wireless channels and to increase the reliability of wireless communication.

Meanwhile, the amount of data required for a cellular network is rapidly increased due to the introduction of Machine-To-Machine (M2M) communication and the appearance and spread of various devices, such as smart phones and tablet PCs. In order to satisfy a large amount of data required, various technologies are being developed. Research is being carried out on Carrier Aggregation (CA) technology for efficiently using more frequency bands, Cognitive Radio (CR) technology, etc. Furthermore, multiple antenna technology, multiple base station cooperation technology, etc. for increasing a data capacity within a limited frequency band are being researched. That is, as a result, a wireless communication system will evolve into the direction toward a higher density of nodes that may be accessed by a user nearby. The performance of a wireless communication system having a high density of nodes may be further improved by cooperation between the nodes. That is, a wireless communication system in which nodes cooperate with each other has more excellent performance than a wireless communication system in which each of nodes operates as an independent Base Station (BS), an Advanced BS (ABS), a Node-B (NB), an eNode-B (eNB), or an Access Point (AP).

In order to improve the performance of a wireless communication system, a Distributed Multi-Node System (DMNS) (hereinafter referred to as a multi-node system) including a plurality of nodes within a cell may be applied. The multi-node system may include a Distributed Antenna System (DAS), a Radio Remote Head (RRH), etc. Furthermore, a standardization task for applying various Multiple-Input Multiple-Output (MIMO) scheme and cooperation communication schemes that have already been developed or that may be applied in the future to the multi-node system is in progress.

There is a need for a method for efficiently measuring, by a terminal, interference in a multi-node system.

### SUMMARY OF THE INVENTION

An object of the present invention is to provide a method and apparatus for measuring interference in a wireless communication system.

As an aspect of if the present invention, a method for measuring interference performed by a user equipment (UE) in a wireless communication system is provided. The method comprises, receiving instruction of a reference resource and an amount of interference correction;

measuring an amount of interference at the reference resource; correcting the measured amount of interference based on the amount of interference correction; and giving feedback at least one of the corrected amount of interference and the channel state information generated based on the corrected amount of interference to the base station.

As another aspect of the present invention, a user equipment (UE) to measure interference in a wireless communication system is provided. The UE comprises a radio frequency (RF) unit to transmit or receive a wireless communication signal, and a processor connected to the RF unit, wherein the processor is configured to perform of: receiving instruction of a reference resource and an amount of interference correction, measuring an amount of interference at the reference resource, correcting the measured amount of interference based on the amount of interference correction, and giving feedback at least one of the corrected amount of interference and the channel state information generated based on the corrected amount of interference to the base station.

In a wireless communication system, a user equipment may compensate the interference measured by itself using the interference correction provided by a base station. The user equipment can compensate the amount of interference in a case that reference resources, where the user equipment measures the amount of interference, do not reflect the UE's serving node appropriately.

### BRIEF DESCRIPTION OF THE DRAWINGS

FIG. 1 is a wireless communication system.

FIG. 2 shows the structure of a radio frame in 3GPP LTE.

FIG. 3 shows an example of a resource grid for a single downlink slot.

FIG. 4 shows the structure of a DL subframe.

FIG. 5 shows the structure of an UL subframe.

FIG. 6 shows an example of a multi-node system.

FIGS. 7 to 9 show examples of an RB to which a CRS is mapped.

FIG. 10 shows an example of an RB to which a CSI-RS is mapped.

FIG. 11 shows the concept of CSI feedback.

FIG. 12 shows an example in which muting resources for interference measurement are configured.

FIG. 13 shows a method of measuring interference according to an embodiment of the present invention.

FIG. 14 is a block diagram showing a wireless communication system which an embodiment of the present invention is implemented on.

### DESCRIPTION OF EXEMPLARY EMBODIMENTS

The following technology may be used in a variety of wireless communication systems, such as Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA). CDMA may be implemented using radio technology, such as Universal Terrestrial Radio Access (UTRA) or CDMA2000. TDMA may be implemented using radio technology, such as Global System for Mobile communications (GSM)/General Packet Radio Service (GPRS)/Enhanced Data Rates for GSM Evolution (EDGE). OFDMA may be implemented using radio technology, such as Institute of Electrical and Electronics Engineers (IEEE) 802.11 (Wi-Fi), IEEE 802.16 (WiMAX), IEEE 802.20, or Evolved-UTRA (E-UTRA). IEEE 802.16m is the evolution of IEEE 802.16e, and it provides backward compatibility with systems based on IEEE 802.16e. UTRA is part of a Universal Mobile Telecommunications System (UMTS). 3rd Generation Partnership Project (3GPP) Long Term Evolution (LTE) is part of an Evolved UMTS (E-UMTS) using Evolved-UMTS Terrestrial Radio Access (E-UTRA), and 3GPP LTE adopts OFDMA in downlink and adopts SC-FDMA in uplink. LTE-Advance (LTE-A) is the evolution of 3GPP LTE.

In order to clarify a description, LTE-A is chiefly described, but the technical spirit of the present invention is not limited thereto.

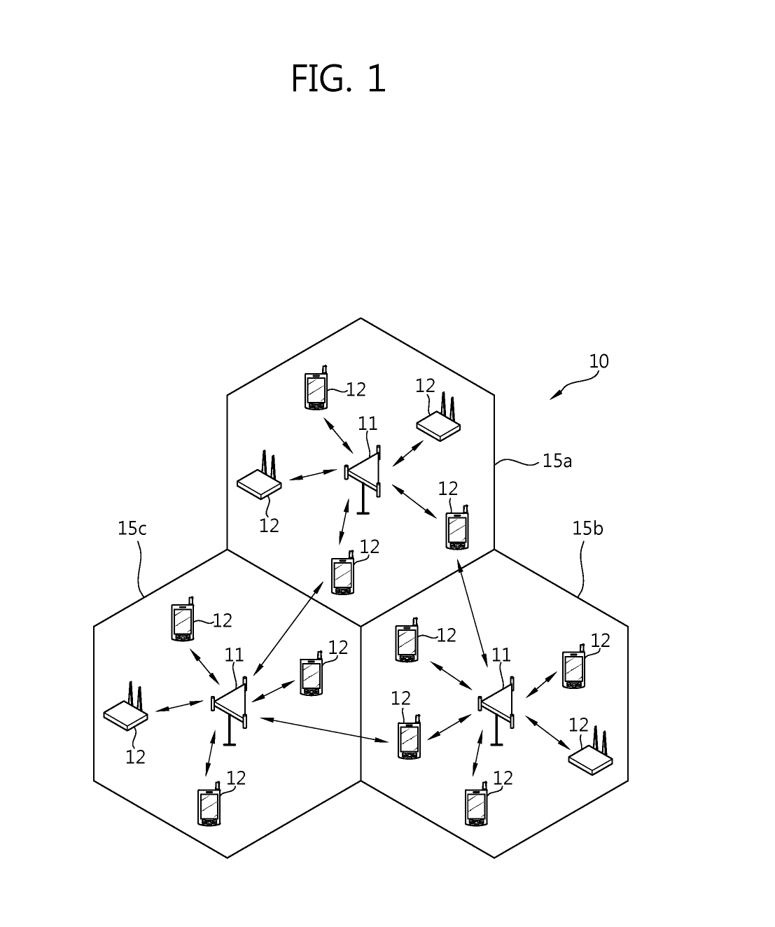

FIG. 1 is a wireless communication system.

The wireless communication system 10 includes one or more Base Stations (BSs) 11. The BSs 11 provide communication service to respective geographical areas (commonly called cells) 15a, 15b, and 15c. The cell may be divided into a plurality of regions (called sectors). User Equipment (UE) 12 may be fixed or mobile and also be called another terminology, such as a Mobile Station (MS), a Mobile Terminal (MT), a User Terminal (UT), a Subscriber Station (SS), a wireless device, a Personal Digital Assistant (PDA), a wireless modem, or a handheld device. The BS 11 commonly refers to a fixed station that communicates with the MSs 12, and the BS may also be called another terminology, such as an evolved NodeB (eNB), a Base Transceiver System (BTS), or an access point.

In general, UE belongs to a single cell, and a cell to which UE belongs is called a serving cell. A BS that provides a serving cell with communication service is called a serving BS. Since a wireless communication system is a cellular system, another cell neighboring a serving cell is present. Another cell neighboring a serving cell is called a neighbor cell. A BS that provides a neighbor cell with communication service is called a neighbor BS. A serving cell and a neighbor cell are relatively determined on the basis of UE.

This technology may be used in downlink or uplink. In general, downlink refers to communication from the BS 11 to the UE 12, and uplink refers to communication from the UE 12 to the BS 11. In downlink, a transmitter may be part of the BS 11, and a receiver may be part of the UE 12. In uplink, a transmitter may be part of the UE 12, and a receiver may be part of the BS 11.

The wireless communication system may be any one of a Multiple-Input Multiple-Output (MIMO) system, a Multiple-Input Single-Output (MISO) system, a Single-Input Single-Output (SISO) system, and a Single-Input Multiple-Output (SIMO) system. An MIMO system uses a plurality of transmit antennas and a plurality of receive antennas. An MISO system uses a plurality of transmit antennas and one receive antenna. An SISO system uses one transmit antenna and one receive antenna. An SIMO system uses one transmit antenna and a plurality of receive antennas. Hereinafter, a transmit antenna means a physical or logical antenna used to send one signal or stream, and a receive antenna means a physical or logical antenna used to receive one signal or stream.

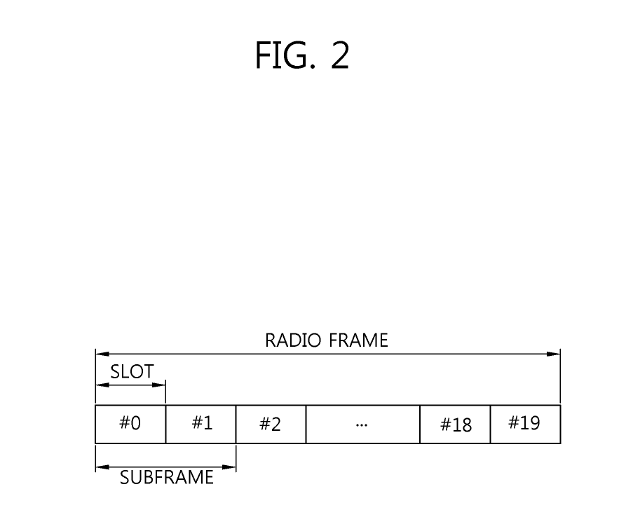

FIG. 2 shows the structure of a radio frame in 3GPP LTE.

For the structure of the radio frame, reference may be made to Paragraph 5 of a 3rd Generation Partnership Project (3GPP) TS 36.211 V10.3.0 (2011-09) “Technical Specification Group Radio Access Network; Evolved Universal Terrestrial Radio Access (E-UTRA); Physical channels and modulation (Release 10)”. Referring to FIG. 2, the radio frame includes 10 subframes, and one subframe includes two slots. The slots within the radio frame are assigned slot numbers from #0 to #19. The time taken for one subframe to be transmitted is called a Transmission Time Interval (TTI). The TTI may be a scheduling unit for data transmission. For example, the length of one radio frame may be 10 ms, the length of one subframe may be 1 ms, and the length of one slot may be 0.5 ms.

A single slot includes a plurality of Orthogonal Frequency Division Multiplexing (OFDM) symbols in a time domain and includes a plurality of subcarriers in a frequency domain. The OFDM symbol is for representing a single symbol period because 3GPP LTE uses OFDMA in downlink and may be called another terminology depending on a multi-access method. For example, if SC-FDMA is used as an uplink multi-access method, the OFDM symbol may be called an SC-FDMA symbol. A Resource Block (RB) is a resource assignment unit, and it includes a plurality of continuous subcarriers in a single slot. The structure of the radio frame is only an example. Accordingly, the number of subframes included in the radio frame, the number of slots included in a subframe, or the number of OFDM symbols included in a slot may be changed in various ways.

In 3GPP LTE, a single slot is defined to include 7 OFDM symbols in a normal Cyclic Prefix (CP), and a single slot is defined to include 6 OFDM symbols in an extended CP.

A wireless communication system may be basically divided into a Frequency Division Duplex (TDD) method and a Time Division Duplex (TDD) method. In accordance with the FDD method, uplink transmission and downlink transmission are performed while occupying different frequency bands. In accordance with the TDD method, uplink transmission and downlink transmission are performed at different points of time while occupying the same frequency band. A channel response in the TDD method is substantially reciprocal. This means that in a given frequency domain, a downlink channel response and an uplink channel response are almost the same. Accordingly, in a wireless communication system based on TDD, there is an advantage in that a downlink channel response may be obtained from an uplink channel response. In the TDD method, downlink transmission by a BS and uplink transmission by UE may not be performed at the same time because the uplink transmission and the downlink transmission are time-divided in the entire frequency band. In a TDD system in which uplink transmission and downlink transmission are divided in a subframe unit, the uplink transmission and the downlink transmission are performed in different subframes.

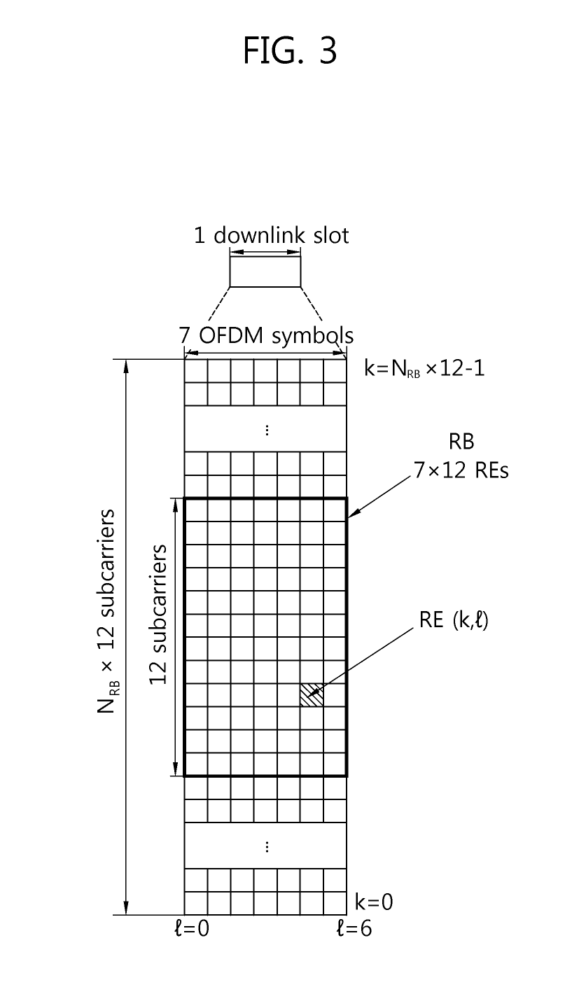

FIG. 3 shows an example of a resource grid for a single downlink slot.

The downlink slot includes a plurality of OFDM symbols in the time domain and includes an N_{RB} number of Resource Blocks (RBs) in the frequency domain. The number of resource blocks NRB included in a downlink slot depends on a downlink transmission bandwidth configured in a cell. For example, in an LTE system, the number of resource blocks N_{RB} may be any one of 6 to 110. A single resource block includes a plurality of subcarriers in the frequency domain. The structure of an uplink slot may be the same as that of the downlink slot.

Each of elements on a resource grid is referred to as a Resource Element (RE). The resource element on the resource grid may be identified by an index pair (k,l) within a slot. In such a case, k (k=0, . . . , N_{RB}×12−1) is a subcarrier index in the frequency domain, and l (l=0, . . . , 6) is an OFDM symbol index in the time domain.

In this case, a single resource block is illustrated as including 7×12 resource elements, including 7 OFDM symbols in the time domain and 12 subcarriers in the frequency domain, but the number of OFDM symbols and the number of subcarriers within the resource block are not limited thereto. The number of OFDM symbols and the number of subcarriers may be changed in various manners depending on the length of a CP, frequency spacing, etc. For example, in the case of a normal CP, the number of OFDM symbols is 7, and in the case of an extended CP, the number of OFDM symbols is 6. In a single OFDM symbol, a single of 128, 256, 512, 1024, 1536, and 2048 may be selected and used as the number of subcarriers.

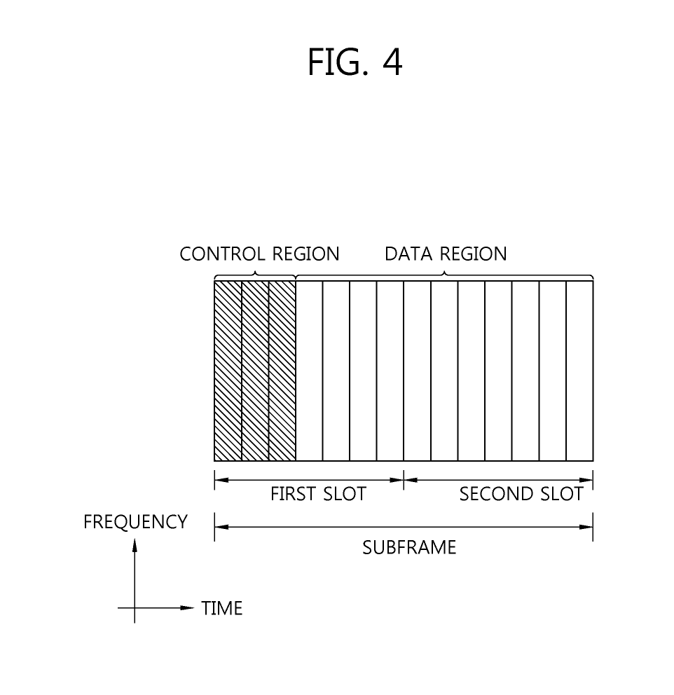

FIG. 4 shows the structure of a DL subframe.

The DL subframe includes two slots in a time domain, and each of the slots includes 7 OFDM symbols in a normal CP. A maximum of the former 3 OFDM symbols (a maximum of 4 OFDM symbols in a 1.4 MHz bandwidth) in the first slot of the DL subframe become a control region to which control channels are assigned, and the remaining OFDM symbols become a data region to which Physical Downlink Shared Channel (PDSCH) are assigned.

A PCFICH transmitted in the first OFDM symbol of a subframe carries a Control Format Indicator (CIF) regarding the size of OFDM symbols (i.e., the size of a control region) that are used for the transmission of control channels within the subframe. UE first receives a CFI on the PCFICH and then monitors a PDCCH. Unlike the PDCCH, the PCFICH is transmitted through the fixed PCFICH resources of the subframe without using blind decoding.

A PHICH carries a positive-acknowledgement (ACK)/negative-acknowledgement (NACK) signal for an UL Hybrid Automatic Repeat Request (HARQ). An ACK/NACK signal for UL data on a PUSCH that is transmitted by UE is transmitted on a PHICH.

A physical broadcast channel (PBCH) is transmitted in the former 4 OFDM symbols of the second slot in the first subframe of a radio frame. The PBCH carries system information that is essential for UE to communicate with a BS, and system information transmitted through a PBCH is called a Master Information Block (MIB). In contrast, system information transmitted on a PDSCH indicated by a PDCCH is called a System Information Block (SIB).

Control information transmitted through a PDCCH is called DL Control Information (DCI). DCI may include the resource assignment of a PDSCH (this is also called a DL grant), the resource assignment of a PUSCH (this is also called an UL grant), a set of transmission power control instructions for individual UE within a specific UE group and/or the activation of a Voice over Internet Protocol (VoIP).

A PDCCH may carry information about the assignment of resources and about the transport format of a Downlink-Shared Channel (DL-SCH), information about the assignment of resources on an Uplink Shared Channel (UL-SCH), paging information on a PCH, system information on a DL-SCH, the resource assignment of a higher layer control message, such as a random access response transmitted on a PDSCH, a set of transmission power control commands for individual UE within a specific MS group, and the activation of a Voice over Internet Protocol (VoIP). A plurality of PDCCHs may be transmitted within the control region, and UE may monitor a plurality of PDCCHs. A PDCCH is transmitted on a single Control Channel Element (CCE) or an aggregation of some contiguous CCEs. A CCE is a logical assignment unit that is used to provide a PDCCH with a coding rate according to the state of a radio channel. A CCE corresponds to a plurality of Resource Element Groups (REGs). The format of a PDCCH and the possible number of bits of a PDCCH are determined by a relationship between the number of CCEs and a coding rate provided by the CCEs.

A BS determines a PDCCH format based on a DCI to be transmitted to UE and attaches Cyclic Redundancy Check (CRS) to control information. A unique identifier (a Radio Network Temporary Identifier (RNTI)) is masked to the CRC depending on the owner or use of a PDCCH. If the PDCCH is a PDCCH for specific UE, an identifier unique to the UE, for example, a Cell-RNTI (C-RNTI) may be masked to the CRC. If the PDCCH is a PDCCH for a paging message, a paging indication identifier, for example, a Paging-RNTI (P-RNTI) may be masked to the CRC. If the PDCCH is a PDCCH for a System Information Block (SIB), a system information identifier, for example, a System Information-RNTI (SI-RNTI) may be masked to the CRC. A Random Access-RNTI (RA-RNTI) may be masked to the CRC in order to indicate a random access response, that is, a response to the transmission of a random access preamble by UE.

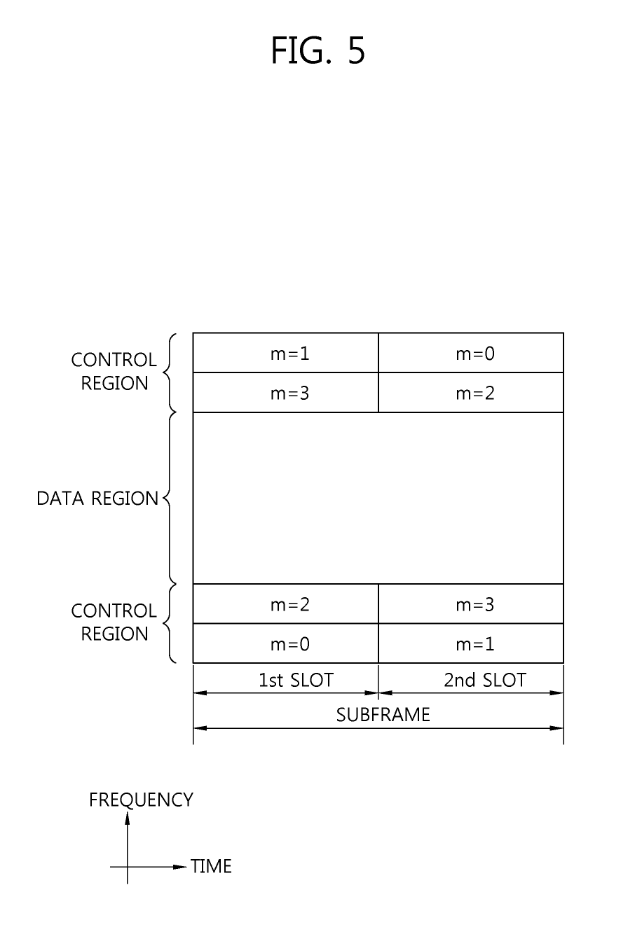

FIG. 5 shows the structure of an UL subframe.

The UL subframe may be divided into a control region and a data region in a frequency domain. A physical uplink control channel (PUCCH) on which uplink control information is transmitted is allocated to the control region. A physical uplink shared channel (PUSCH) on which data is transmitted is allocated to the data region. If indication is made by an upper layer, UE may support the simultaneous transmission of a PUSCH and a PUCCH.

A PUCCH for a single MS is assigned as an RB pair in a subframe. Resource blocks belonging to the RB pair occupy different subcarriers in a first slot and a second slot. A frequency occupied by a resource block that belongs to the RB pair assigned to the PUCCH is changed based on a slot boundary. This is said that the RB pair assigned to the PUCCH has been subject to frequency-hopping at the slot boundary. The MS may obtain a frequency diversity gain by sending uplink control information through different subcarriers over time. m is a location index indicative of the location of a logical frequency domain of the RB pair assigned to the PUCCH in the subframe.

UL control information transmitted on a PUCCH includes Hybrid Automatic Repeat Request (HARQ) acknowledgement (ACK), a Channel Quality Indicator (CQI) indicative of a downlink channel state, and a Scheduling Request (SR), that is, an uplink radio resource assignment request.

A PUSCH is mapped to an UL-SCH that is a transport channel. Uplink data transmitted on the PUSCH may be a transport block, that is, a data block for the UL-SCH transmitted during a TTI. The transport block may be user information, or the uplink data may be multiplexed data. The multiplexed data may be obtained by multiplexing the transport block for the UL-SCH and control information. For example, control information multiplexed with data may include a CQI, a Precoding Matrix Indicator (PMI), HARQ, and a Rank Indicator (RI). Alternatively, the uplink data may include only the control information.

In order to improve the performance of a wireless communication system, technology evolves toward the direction in which the density of nodes accessible to users nearby is increased. The performance of a wireless communication system having a high density of nodes can be further improved through cooperation between the nodes.

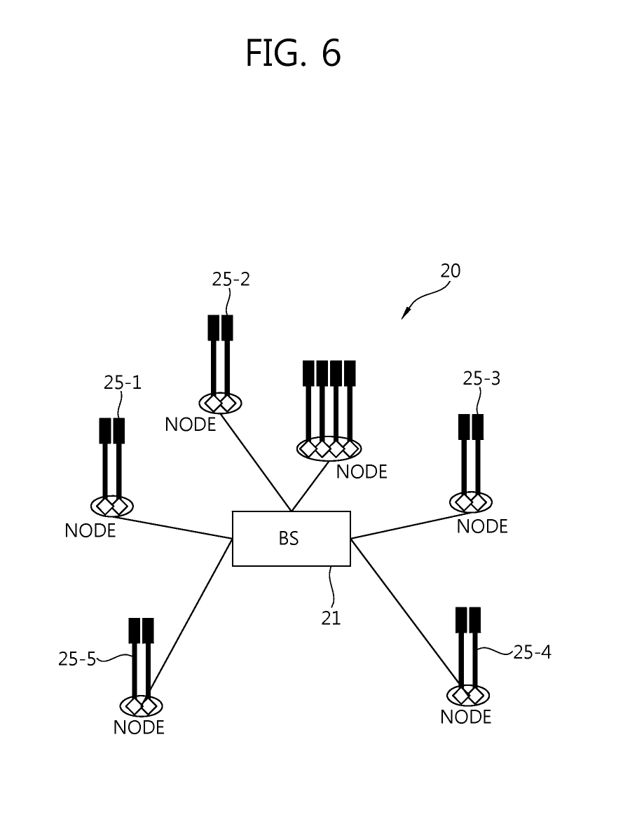

FIG. 6 shows an example of a multi-node system.

Referring to FIG. 6, a multi-node system 20 may consist of a single BS 21 and a plurality of nodes 25-1, 25-2, 25-3, 25-4, and 25-5. The plurality of nodes 25-1, 25-2, 25-3, 25-4, and 25-5 may be managed by the single BS 21. That is, the plurality of nodes 25-1, 25-2, 25-3, 25-4, and 25-5 operates like part of a single cell. In this case, each of the nodes 25-1, 25-2, 25-3, 25-4, and 25-5 may be assigned a separate node identifier (ID), or may operate like some antenna group within a cell without a separate node ID. In such a case, the multi-node system 20 of FIG. 6 may be considered to be a Distributed Multi-Node System (DMNS) that form a single cell.

Alternatively, the plurality of nodes 25-1, 25-2, 25-3, 25-4, and 25-5 may have respective cell IDs, and may perform the scheduling and handover (HO) of UE. In such a case, the multi-node system 20 of FIG. 6 may be considered to be a multi-cell system. The BS 21 may be a macro cell, and each of the nodes may be a femto cell or pico cell that has smaller cell coverage than the macro cell. If, as described above, a plurality of cells is overlaid and configured according to coverage, this may be called a multi-tier network.

In FIG. 6, each of the nodes 25-1, 25-2, 25-3, 25-4, and 25-5 may be any one of a BS, a Node-B, an eNode-B, a pico cell eNb (PeNB), a home eNB (HeNB), a Radio Remote Head (RRH), a Relay Station (RS) or a repeater, and a distributed antenna. At least one antenna may be installed in a single node. Furthermore, the node may also be called a point. In the following specification, a node means an antenna group that is spaced apart from a multi-node system at a specific interval or higher. That is, in the following specification, each node is assumed to be an RRH physically. However, the present invention is not limited thereto, and a node may be defined as a specific antenna group regardless of a physical interval. For example, assuming that a BS consisting of a plurality of cross-polarized antennas includes nodes formed of horizontal-polarized antennas and nodes formed of vertical-polarized antennas, the present invention may be applied. Furthermore, the present invention may also be applied even in the case where each node is a pico cell or a femto cell having smaller cell coverage than a macro cell, that is, in a multi-cell system. In the following description, an antenna may be replaced with an antenna port, a virtual antenna, or an antenna group in addition to a physical antenna.

Also, the node is not limited to the node in physical aspect, but may be extended to the node in logical aspect. Here, the node in logical aspect may signify the pilot signal (which may also be called a reference signal) that can be detected as a node from the point of view of a UE. For example, the UE operating in LTE may detect the configuration information of a node through the port of the cell-specific reference signal (CRS) or the channel state information-reference signal (CSI-RS). Accordingly, the node may differ for the UE depending on the point of view which is logical or physical.

As an example, in the cell where the N of CRS ports are transmitted, the LTE UE may detect that the cell includes a node having N transmission antennas. However, actual physical configuration of the cell may be various. For example, each of the two nodes in the cell may transmit N/2 CRS ports. Or, multiple nodes having N transmission antennas in the cell may transmit the N CRS ports as the form of single frequency network (SFN).

The relationship between the node in physical aspect and the node in logical aspect may not be recognized or be necessary to be recognized by a UE. This is commonly expressed as the term, transparent. Accordingly, the UE may recognize the node (logical node) in the logical aspect and perform the process of transmission and reception. In the future LTE-A system, the logical node may be detected through a CSI-RS resource (or pattern). For example, if multiple CSI-RS resources are configured for a UE, the UE may detect each of the CSI-RS resources to be a logical node and may perform the process of transmission and reception.

Furthermore, the present invention may also be applied even in the case where each node is a pico cell or a femto cell having smaller cell coverage than a macro cell, that is, in a multi-cell system. In the following description, an antenna may be replaced with an antenna port, a virtual antenna, or an antenna group in addition to a physical antenna.

<Coordinated Multipoint Transmission and Reception (CoMP)>

The CoMP signifies a cooperative communication method among nodes. In a multi cell multi node system, the Inter-Cell interference may be decreased, and in a single cell multi node system, the Intra-Cell inter-point interference may be decreased by applying the CoMP.

When using the CoMP, the UE may receive data from the multiple nodes. Also, each of the base stations may support one or more UE as the same time by using the same frequency resource in order to improve the performance of the system.

The base station may perform the method of space division multiple access (SDMA) based on the channel state information of the channel between the base station and the UE.

The main purpose of the CoMP is to improve the communication performance of the UEs located on the border of cell or node. In LTE, the CoMP transmission technique is divided by joint processing (JP) and coordinated scheduling/coordinated beamforming (CS/CB).

The JP is the CoMP technique that transmits data while sharing data with one or more nodes. The CS/CB is the CoMP technique in which data transmission is performed by a node, and the other nodes cooperate with serving nodes in the direction of decreasing the interference of scheduling or transmission beam.

In the JP, dynamic point selection (DPS), joint transmission (JT), and the like are included. The JT is the technique in which data is transmitted from multiple nodes to a UE or multiple UEs at the same time. The data for a UE is transmitted from multiple nodes at the same time.

In the DPS, data is usable for multiple nodes, but data is transmitted from a node. In this time, the transmission node/muting node may be changed by a subframe. The DPS includes dynamic cell selection.

In the CS/CB technique, semi-static point selection (SSPS) is included. The transmission for a specific UE is performed by a node, and which node transmits is changed with semi-static manner.

A Reference Signal (RS) is described.

An RS is commonly transmitted in the form of a, sequence. A specific sequence may be used as an RS sequence without special limits. A Phase Shift Keying (PSK)-based computer generated sequence based on PSK may be used as the RS sequence. PSK may include, for example, Binary Phase Shift Keying (BPSK) and Quadrature Phase Shift Keying (QPSK). Alternatively, a Constant Amplitude Zero Auto-Correlation (CAZAC) sequence may be used as the RS sequence. The CAZAC sequence may include, for example, a Zadoff-Chu (ZC)-based sequence, a ZC sequence with cyclic extension, and a ZC sequence with truncation. Alternatively, a pseudo-random (PN) sequence may be used as the RS sequence. The PN sequence may include, for example, an m-sequence, a computer-generated sequence, a gold sequence, and a Kasami sequence. Alternatively, a cyclically shifted sequence may be used as the RS sequence.

A DL RS may be classified into a Cell-specific Reference Signal (CRS), a Multimedia Broadcast and multicast Single Frequency Network (MBSFN) RS, a UE-specific RS, a Positioning RS (PRS), and a Channel State Information-RS (CSI-RS). The CRS is an RS transmitted to all pieces of UE within a cell, and the CRS may be used for the channel measurement of Channel Quality Indicator (CQI) feedback and the channel estimation of a PDSCH. The MBSFN RS may be transmitted in a subframe assigned for the transmission of an MBSFN. The UE-specific RS is an RS received by specific UE or a specific UE group within a cell, and may be called a demodulation RS (DMRS). The DMRS may be used for specific UE or a specific UE group to perform data demodulation. The PRS may be used to estimate the location of UE. The CSI-RS is used for the channel estimation of the PDSCH of LTE-A UE. The CSI-RS is relatively sparsely disposed in a frequency domain or a time domain, and may be punctured in the data region of a common subframe or MBSFN subframe. A CQI, a PMI, an RI, etc. may be reported by UE through the estimation of a CSI, if necessary.

The CRS is transmitted from all downlink subframe in the cell that supports the PDSCH transmission. The CRS may transmit on 0 to 3 antenna ports, and may be defined only for subcarrier interval Δf=15 kHz. The pseudo-random sequence r_{l,ns}(m) generated on the seed value which is based on the cell identity (ID) is mapped to the resource of complex-valued modulation symbol) a^{(p)}_{k,l}. Here, nₛ is the slot number in a radio frame, p is an antenna port, and l is the number of the OFDM symbol in slot. And k is the subcarrier index. Herein l and k are represented as following Equation.

$$l = \{ \begin{matrix}0 , {N}_{symb}^{DL} - 3 & if p ∈ \{ 0 , 1 \} \\ 1 & if p ∈ \{ 2 , 3 \}\end{matrix} \\ k = 6 m + ( v + {v}_{shift} ) mod 6 , \\ {v}_{shift} = {N}_{ID}^{cell} mod 6 \qquad [ Equation 1 ]$$

As shown in Equation 1, l is determined according to the antenna port p, and k has 6 shifted indexes according to cell ID(N^{Cell}_{ID}). The RE allocated to the CRS of an antenna port cannot be used for the transmission of another antenna port, and should be configured to zero. Also, in the multicast-broadcast single frequency network (MBSFN) subframe, the CRS is transmitted only to non-MBSFN region.

For the CRS, reference may be made to section 6.10.1 of 3^{rd} Generation Partnership Project (3GPP) TS 36.211 V10.1.0 (2011-03) “Technical Specification Group Radio Access Network; Evolved Universal Terrestrial Radio Access (E-UTRA); Physical channels and modulation (Release 8)”.

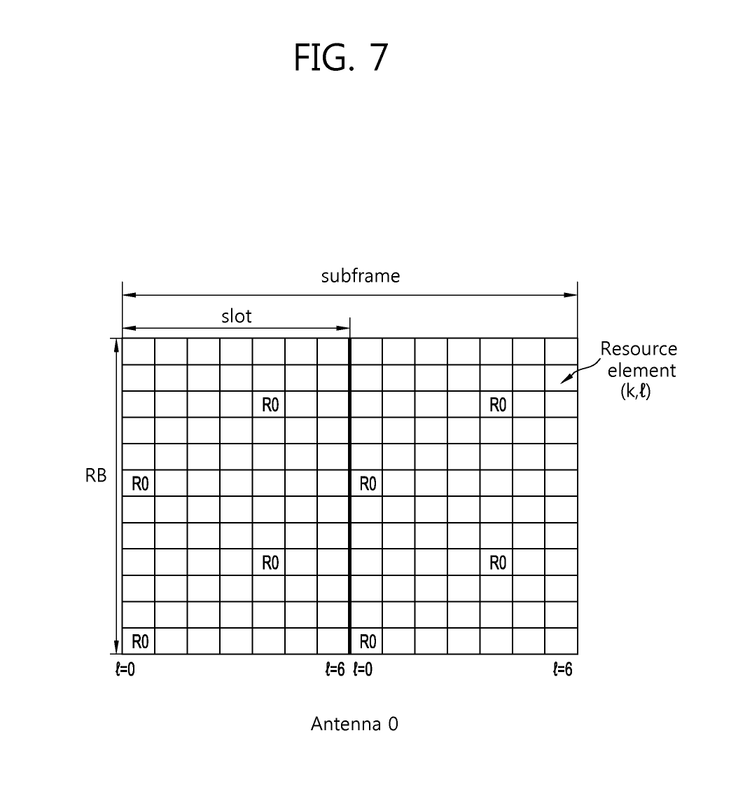

FIGS. 7 to 9 show examples of an RB to which a CRS is mapped.

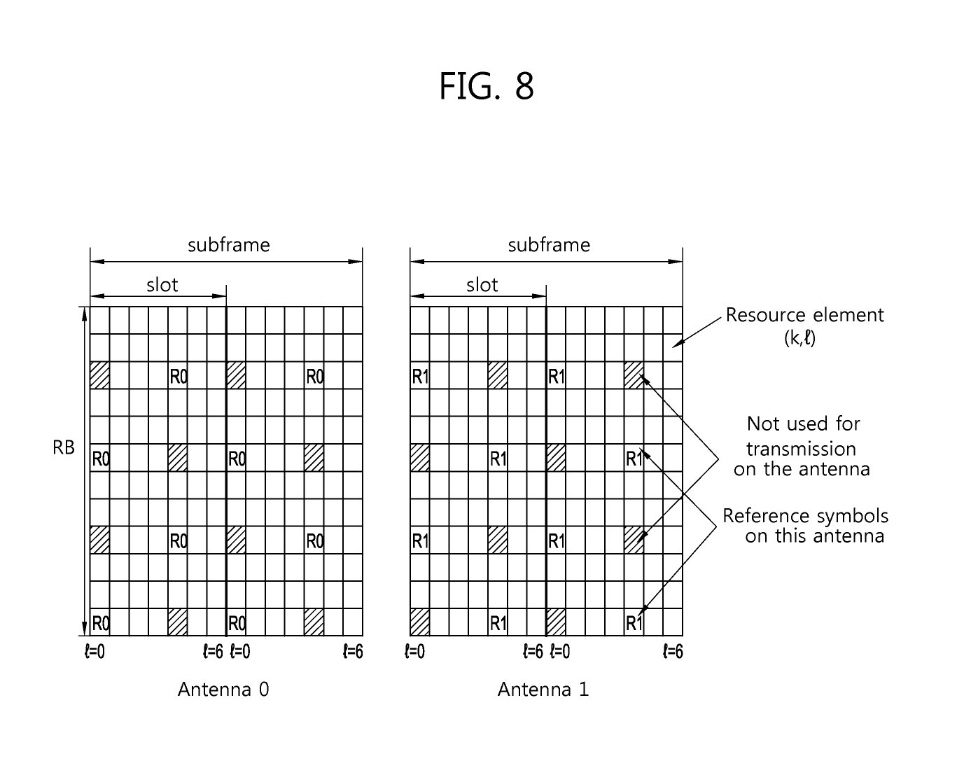

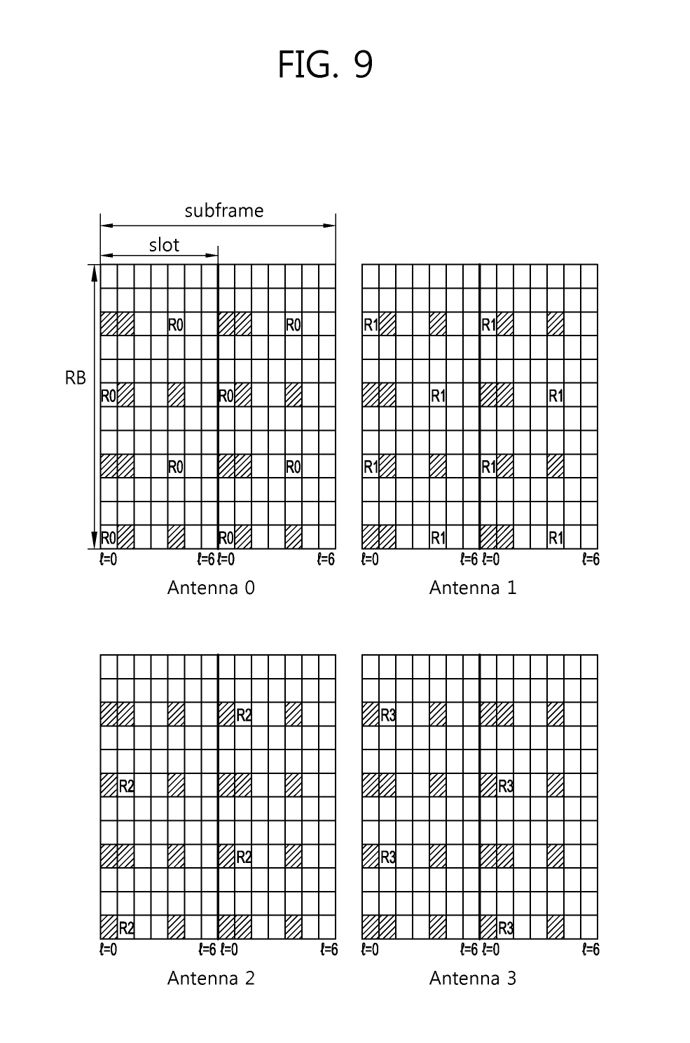

FIG. 7 shows an example of a pattern in which a CRS is mapped to RB if a BS uses a single antenna port, FIG. 8 shows an example of a pattern in which a CRS is mapped to RB if a BS uses two antenna ports, and FIG. 9 shows an example of a pattern in which a CRS is mapped to RB if a BS uses four antenna ports. Furthermore, the CRS pattern may be used to support the characteristics of LTE-A. For example, the CRS pattern may be used to support the characteristics of a Coordinated Multi-Point (CoMP) transmission reception scheme or spatial multiplexing. Furthermore, the CRS may be used for channel quality measurement, the detection of a CP, and time/frequency synchronization.

Referring to FIGS. 7 to 9, in the case of multiple antenna transmission when a BS uses a plurality of antenna ports, a single resource grid is present in each antenna port. ‘R0’ indicates an RS for a first antenna port, ‘R1’ indicates an RS for a second antenna port, ‘R2’ indicates an RS for a third antenna port, and ‘R3’ indicates an RS for a fourth antenna port. Locations the subframes of R0 to R3 are not overlapped with each other. l is the location of an OFDM symbol within a slot, and it has a value between 0 and 6 in a normal CP. In a single OFDM symbol, an RS for each antenna port is placed at 6-subcarrier intervals. The number or R0 and the number of R1 within a subframe are the same, and the number of R2 and the number of R3 are the same. The number of R2 and R3 within a subframe is smaller than the number of R0 and R1. A resource element used in the RS of one antenna port is not used in the RS of other antennas. This reason for this is that antenna ports do not interfere with each other.

A CSI-RS is transmitted through 1, 2, 4, or 8 antenna ports. In this case, the antenna port used are p=15, p=15, 16, p=15, . . . , 18 and p=15, . . . , 22, respectively. A CSI-RS may be defined for only Δf=15 kHz. For a CSI-RS, reference may be made to Paragraph 6.10.5 of 3GPP TS 36.211 V10.1.0 (2011-03) “Technical Specification Group Radio Access Network; Evolved Universal Terrestrial Radio Access (E-UTRA); Physical channels and modulation (Release 8)”

In the transmission of a CSI-RS, in a multi-cell environment including a heterogeneous network (HetNet) environment, a maximum of 32 different configurations may be proposed in order to reduce Inter-Cell Interference (ICI). The CSI-RS configuration is different depending on the number of antenna ports within a cell and a CP, and neighboring cells may have different configurations to the highest degree. Furthermore, the CSI-RS configuration may be divided into a case where it is applied to both an FDD frame and a TDD frame and a case where it is applied to only a TDD frame depending on a frame structure. In a single cell, a plurality of CSI-RS configurations may be used. 0 or 1 CSI-RS configuration may be used in UE that assumes a non-zero power CSI-RS, and 0 or multiple CSI-RS configurations may be used in UE that assumes a zero-power CSI-RS.

The CSI-RS is mapping the pseudo-random sequence r_{l,ns}(m) generated on the seed value based on the cell identity (ID) to the resource of complex-valued modulation symbol) a^{(p)}_{k,l}. Here, nₛ is the slot number in a radio frame, p is the antenna port, and l is the number of the OFDM symbol in slot and are represented as following Equation 2 according to the CSI reference signal configuration index. And k is the subcarrier index and determined as following Equation 2.

$$k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix\end{matrix} \\ l = {l}^{′} + \{ \begin{matrix}{l}^{″} & CSI reference signal configurations 0 \text{-} 19 , \\ & normal cyclic prefix \\ 2 {l}^{″} & \begin{matrix}CSI reference signal configurations 20 \text{-} 31 , \\ normal cyclic prefix\end{matrix}\end{matrix} \qquad [ Equation 2 ]$$

The CSI-RS configuration may be instructed by the higher layer (for example, the radio resource control (RRC) layer). The CSI-RS-Config information element (IE) transmitted through the higher layer may instruct the CSI-RS configuration. The CSI-RS-Config IE may be a UE-specific message. That is, different CSI-RS-Config IE may be transmitted to each UE. Table 1 represents an example of the CSI-RS-Config IE.

TABLE 1
--ASN1START

| | |
|---|---|
| CSI-RS-Config-r10 ::= | SEQUENCE { |

| | |
|---|---|
| csi-RS-r10 | CHOICE { |

| | |
|---|---|
| release | NULL, |

| | |
|---|---|
| setup | SEQUENCE { |
| antennaPortsCount-r10 | ENUMERATED {an1, an2, an4, an8}, |
| resourceConfig-r10 | INTEGER (0..31), |
| subframeConfig-r10 | INTEGER (0..154), |
| p-C-r10 | INTEGER (−8..15) |

}

}

| | |
|---|---|
| OPTIONAL, | -- Need ON |

| | |
|---|---|
| zeroTxPowerCSI-RS-r10 | CHOICE { |

| | |
|---|---|
| release | NULL, |

| | |
|---|---|
| setup | SEQUENCE { |

| | |
|---|---|
| zeroTxPowerResourceConfigList-r10 | BIT STRING (SIZE (16)), |
| zeroTxPowerSubframeConfig-r10 | INTEGER (0..154) |

}

}

| | |
|---|---|
| OPTIONAL | -- Need ON |

}
--ASN1STOP

Referring to Table 1, the antennaPortsCount field indicates the number of antenna ports used for the transmission of a CSI-RS. The resourceConfig field indicates a CSI-RS configuration. The SubframeConfig field and the zeroTxPowerSubframeConfig field indicate a subframe configuration transmitted by the CSI-RS.

The zeroTxPowerResourceConfigList field indicates a zero-power CSI-RS configuration. In a 16-bit bitmap that forms the zeroTxPowerResourceConfigList field, a CSI-RS configuration corresponding to a bit set to 1 may be configured as a zero-power CSI-RS. More specifically, the Most Significant Bit (MSB) of the bitmap that forms the zeroTxPowerResourceConfigList field corresponds to the first CSI-RS configuration index if the number of CSI-RSs is four in Tables 2 and 3. Subsequent bits in the bitmap that forms the zeroTxPowerResourceConfigList field correspond in the direction in which a CSI-RS configuration index is increased if the number of CSI-RSs is 4 in Tables 2 and 3. That is, multiple CSI-RS configurations may be used in a cell. The non zero-power CSI-RS may use 0 or 1 configuration and the zero-power CSI-RS may use 0 or multiple configurations. Table 2 shows the configuration of a CSI-RS in a normal CP, and Table 3 shows the configuration of a CSI-RS in an extended CP.

TABLE 2

| | | Number of configured CSI-RSs | | | | | |
|---|---|---|---|---|---|---|---|
| | CSI RS | 1 or 2 | | 4 | | 8 | |
| | config- | | nₛ | | nₛ | | nₛ |
| | uration | (k′, l′) | mod 2 | (k′, l′) | mod 2 | (k′, l′) | mod 2 |
| TDD | 0 | (11, 4) | 0 | (11, 4) | 0 | (11, 4) | 0 |
| and | 1 | (9, 4) | 0 | (9, 4) | 0 | (9, 4) | 0 |
| FDD | 2 | (10, 4) | 1 | (10, 4) | 1 | (10, 4) | 1 |
| frame | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| TDD | 16 | (11, 1) | 1 | (11, 1) | 1 | (11, 1) | 1 |
| frame | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

TABLE 3

| | | Number of configured CSI-RSs | | | | | |
|---|---|---|---|---|---|---|---|
| | CSI RS | 1 or 2 | | 4 | | 8 | |
| | config- | | nₛ | | nₛ | | nₛ |
| | uration | (k′, l′) | mod 2 | (k′, l′) | mod 2 | (k′, l′) | mod 2 |
| TDD | 0 | (11, 4) | 0 | (11, 4) | 0 | (11, 4) | 0 |
| and | 1 | (9, 4) | 0 | (9, 4) | 0 | (9, 4) | 0 |
| FDD | 2 | (10, 4) | 1 | (10, 4) | 1 | (10, 4) | 1 |
| frame | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| TDD | 16 | (11, 1) | 1 | (11, 1) | 1 | (11, 1) | 1 |
| frame | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0.1) | 1 | | | | |

Referring to Table 2, the bits of the bitmap that forms the zeroTxPowerResourceConfigList field correspond to the respective CSI-RS configuration indices 0, 1, 2, 3, 4, 5, 6, 7, 8, 9, 20, 21, 22, 23, 24, and 25 from the MSB (most significant bit). Referring to Table 3, the bits of the bitmap that forms the zeroTxPowerResourceConfigList field correspond to the respective CSI-RS configuration indices 0, 1, 2, 3, 4, 5, 6, 7, 16, 17, 18, 19, 20 and 21 from the MSB. UE may assume resource elements, corresponding to the CSI-RS configuration indices set as a zero-power CSI-RS, as resource elements for the zero-power CSI-RS. However, resource elements set as resource elements for a non-zero power CSI-RS by a higher layer may be excluded from the resource elements for the zero-power CSI-RS.

The UE may send a CSI-RS only in a downlink slot that satisfies the condition of nₛ mod 2 in Tables 2 and 3. Furthermore, the UE does not send a CSI-RS in a special subframe of a TDD frame, a subframe in which the transmission of the CSI-RS collides against a synchronization signal, a physical broadcast channel (PBCH), an SIB type 1 ‘SystemInformationBlockType1’, or a subframe in which a paging message is transmitted. Furthermore, in a set S, that is, S={15}, S={15, 16}, S={17, 18}, S={19, 20}, or S={21, 22}, resource elements in which the CSI-RS of a single antenna port is transmitted are not used in the transmission of a PDSCH or the CSI-RS of another antenna port.

Table 4 shows an example of subframe configurations in which a CSI-RS is transmitted.

TABLE 4

| CSI-RS-SubframeConfig | CSI-RS periodicity | CSI-RS subframe offset |
|---|---|---|
| I_{CSI-RS} | T_{CSI-RS} (subframes) | Δ_{CSI-RS} (subframes) |
| 0-4 | 5 | I_{CSI-RS} |
| 5-14 | 10 | I_{CSI-RS}-5 |
| 15-34 | 20 | I_{CSI-RS}-15 |
| 35-74 | 40 | I_{CSI-RS}-35 |
| 75-154 | 80 | I_{CSI-RS}-75 |

Referring to Table 4, the periodicity T_{CSI-RS} and offset Δ_{CSI-RS} of a subframe in which a CSI-RS is transmitted may be determined depending on a CSI-RS subframe configuration I_{CSI-RS.} The CSI-RS subframe configuration of Table 4 may be any one of the SubframeConfig field and the ZeroTxPowerSubframeConfig field in the CSI-RS-Config IE of Table 1. The configuration of the CSI-RS subframe may be separately configured with regard to the non zero-power CSI-RS and the zero-power CSI-RS, respectively. Meanwhile, the subframe that transmits the CSI-RS may satisfy Equation 3.

(10n_{f}+└nₛ/2┘−Δ_{CSI-RS})mod T_{CSI-RS}=0 [Equation 3]

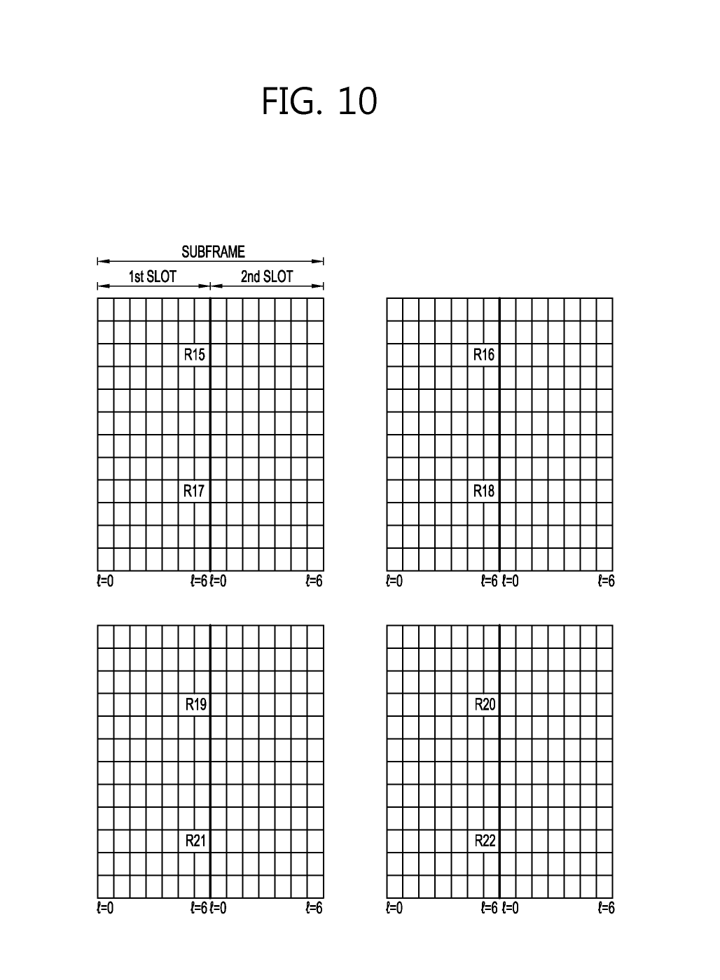

FIG. 10 shows an example of an RB to which a CSI-RS is mapped.

FIG. 10 shows resource elements used for a CSI-RS when a CSI-RS configuration index is 0 in a normal CP structure. Rp indicates a resource element used in the transmission of a CSI-RS on an antenna port p. Referring to FIG. 10, a CSI-RS for an antenna port 15, 16 is transmitted through a resource element corresponding to the third subcarrier (a subcarrier index 2) of the sixth and the seventh OFDM symbols (OFDM symbol indices 5 and 6) of a first slot. A CSI-RS for an antenna port 17, 18 is transmitted through a resource element corresponding to the ninth subcarrier (a subcarrier index 8) of sixth and seventh OFDM symbols (OFDM symbol indices 5 and 6) of the first slot. A CSI-RS for an antenna port 19, 20 is transmitted through a resource element corresponding to the fourth subcarrier (a subcarrier index 3) of the sixth and the seventh OFDM symbols (OFDM symbol indices 5 and 6) of the first slot. A CSI-RS for an antenna port 21, 22 is transmitted through a resource element corresponding to the tenth subcarrier (a subcarrier index 9) of the sixth and the seventh OFDM symbols (OFDM symbol indices 5 and 6) of the first slot.

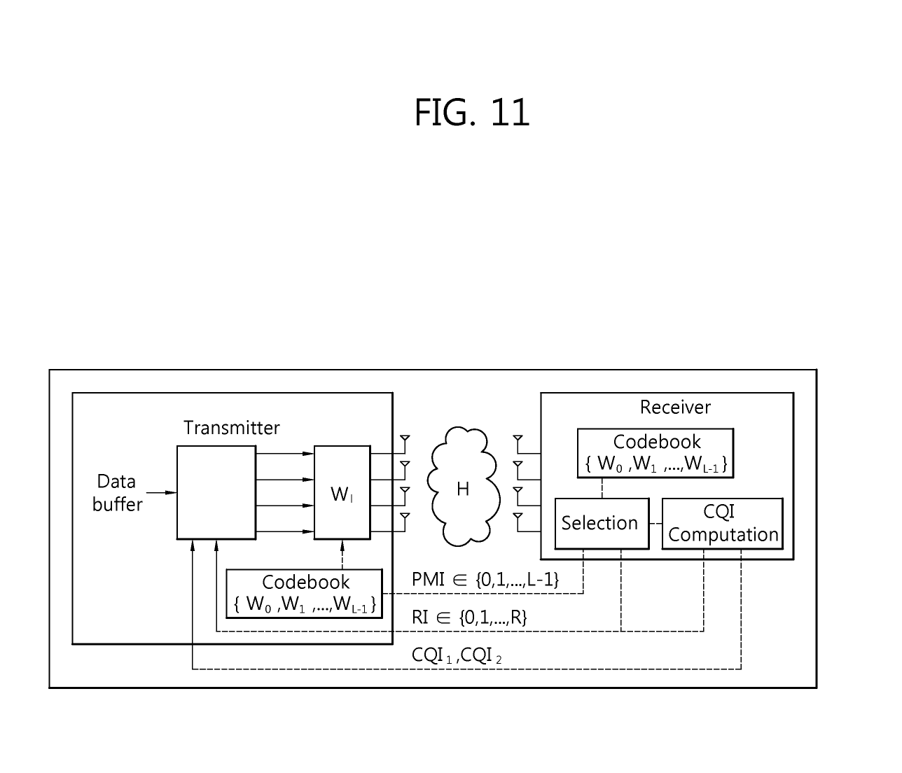

FIG. 11 shows the concept of CSI feedback.

Referring to FIG. 11, when a transmitter sends an RS, for example, a CSI-RS, a receiver measures a CSI-RS, generates CSI, and feeds the CSI-RS back to the transmitter. The CSI includes a Precoding Matrix Index (PMI), rank indication (RI), a Channel Quality Indicator (CQI), etc.

An RI is determined by the number of assigned transport layers and obtained from related DCI. The PMI is applied to closed loop multiplexing and a large delay CDD. The receiver calculates the post-processing SINR of each PMI in relation to each of rank values 1 to 4, converts the calculated SINR into a sum capacity, and selects an optimum PMI from a codebook based on the sum capacity. Furthermore, the receiver determines an optimum RI based on the sum capacity. The CQI indicates channel quality, and a 4-bit index may be given as in the following table. UE may feed the indices of the following table back.

TABLE 5
CQI Table

| CQI index | modulation | coding rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In general, in CSI measurement, in particular, in CQI measurement, an accurate Modulation and Coding Scheme (MCS) level may be determined only when the amount of interference is accurately measured. In the LTE standard specification, how UE measures interference using what method has not been defined in detail. In general, however, interference power is measured in such a way as to measure a channel with a serving cell using a CRS and subtract the transmission power of the serving cell from the total reception power of the UE.

The method of interference measurement based on the CRS is likely to become inaccurate while new functions are added in LTE. For example, the CRS RE which is a resource element in which the CRS is allocated exists in both of the PDCCH region and the PDSCH region and if the interferences in the PDCCH region and in the PDSCH region are different from each other, the interference measurement becomes inaccurate. For example, in the case that the interference cell that influences in interference is in the situation of an empty buffer or in the case that the almost blank subframe (ABS) is applied for the operation of enhanced inter-cell interference cancellation (eICIC), the interference measurement becomes inaccurate since the interferences in the PDCCH region and in the PDSCH region can be different.

Also, in case of the CRS, in order to avoid the CRS collision occurred by transmitting CRS using the same resource with that of the neighboring cell, different frequency shift values may be configured in the serving cell and in the neighboring cell. However, since the number of the frequency shift values are limited (for example, 3 values), the collision among the CRSs becomes unavoidable in the situation that cells are more and more congested.

Also, in the single cell multi node system in which multiple nodes use the identical cell ID is there a problem that the interference among different nodes in the cell and the UE is not able to be measured by the CRS. Since the CRS is generated based on cell ID and multiple nodes in the cell are able to use the same CRS in the multi node system, it is hard for the UE to separately measure the interference by dividing channel for each node.

As a way to solve the problem occurred in measuring interference based on the CRS, there is a method of designating the interference measurement resource region by using the zero-power CSI-RS configuration.

The method is to measure the interference by the UE at the corresponding RE by designating specific REs as interference measuring REs to the UE. For example, assuming that there exist three nodes such as nodes A, B and C exist in the multi node system. The base station may control that node A does not transmit any signal (that is, let node A be muted) at a specific RE where nodes B and C transmit data. And the base station may perform the above-described control process by allocating the CSI-RS configuration in which the transmission power is not zero at the specific RE to nodes B and C, and by allocating the zero-power CSI-RS in which the transmission power is zero at the specific RE to node A. In the situation described above, the base station may let the UE that is going to receive data from node A measure the interference at the specific RE. Then, the UE may accurately measure the interference occurred by nodes B and C.

In case that the above described method of measuring interference is applied, which is based on the zero-power CSI-RS, it is necessary to notify a UE whether the resource which the corresponding zero-power CSI-RS is allocated to is 1) or 2) when the zero-power CSI-RS is configured 1) for measuring interference or 2) for decreasing the interference on node around. This is because the operation of the UE may be changed according to 1) and 2). Accordingly, either can be considered from the method of adding the information that notifies the object or use of the zero-power CSI-RS to the existing zero-power CSI-RS configuration message or the method of modifying and compensating the existing zero-power CSI-RS configuration message.

This approach is to maintain the UE-specific characteristics of the existing CSI-RS configuration for the backward compatibility. When utilizing the UE-specific characteristics, it is able to configure different interference measurement resource regions according to different serving node sets for each UE.

Here, the serving node set is the nodes being excluded in the measurement of interference with the assumption that it does not give interfere to the UE. As an example, it may be the same as one of CoMP cooperation set, CoMP measurement set, radio resource management (RRM) and CoMP transmission point, which are defined in the LTE Cooperative multi-point transmission and reception (CoMP).

However, as described above, in case of configuring different interference measurement resource region according to different serving node sets for each UE, a problem may occur that the muting resource overhead for the measurement of interference is significantly increased.

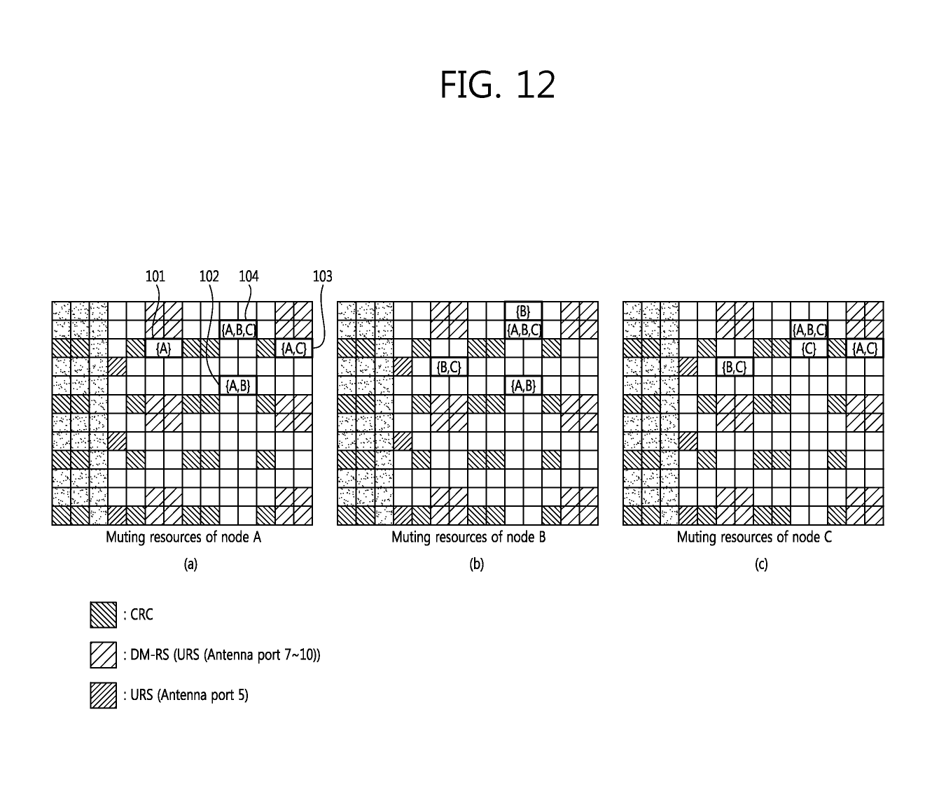

FIG. 12 shows an example of configuring the muting resource for the measurement of interference.

The resource region represented by {X} in FIG. 12 is the region where the zero-power CSI-RS is configured in the node X and muted. For example, {A} represents the region in which node A is muted and {A, B} represents the region in which nodes A and B are muted. The UE having the node X as a serving node set measures the interference affected by the nodes except the node X in the resource region represented as {X}.

For example, it is assumed that nodes A, B, and C are present and a plurality of pieces of UE is present in a multi-node system. The plurality of pieces of UE may receive UE that receives signals from only one of the nodes A, B, and C, UE that receives signals from two of the nodes A, B, and C, and UE that receives signals from all the nodes A, B, and C.

If the UE receivers data from only the node A, the UE needs to measure interference from the nodes B and C. In such a case, the UE measures interference from the nodes B and C in a resource region 101 indicated by {A} in FIG. 12(a). In the resource region 101, a zero-power CSI-RS is set in the node A, and thus the node A is muted.

Likewise, if the UE receives data from the nodes A and B, the UE needs to measures interference from the node C. In such a case, the UE measures interference from the node C in a resource region 102 indicated by {A,B} in FIG. 12(a). In the resource region 102, a zero-power CSI-RS is set in the nodes A and B, and thus the nodes A and B are muted.

A resource region 104 indicated by {A,B,C} may be a region for measuring the interference of other cells that neighbor a cell including the nodes A, B, and C. That is, in the resource region 104, a zero-power CSI-RS is set in all the nodes A, B, and C, and thus all the nodes A, B, and C are muted.

As shown in FIG. 12, each of the nodes A, B, and C needs to have four muting patterns (e.g., the regions 101, 102, 103, and 104 for the node A) in a single RB pair, and a total number of muting patterns that is assigned to the RB pair and distinguished from each other is 7.

If this is generally expanded, in a multi-node system including N nodes, a maximum of (2^{N}−1) muting patterns are required. Each of the N nodes may have to mute a maximum of 2^{(N-1)} patterns. A CSI-RS pattern that is 2TX transmission and in which a CSI-RS transmission periodicity T_{CSI-RS} is T ms (i.e., T subframes) requires muting resource overhead corresponding to 2 RE/(12·14·T)RE=0.0119/T in relation to a normal subframe. Accordingly, each node requires muting resource overhead corresponding to 2^{(N-1)}·0.0119/T. For example, if the number of nodes is N=6 and T=5 ms, muting resource overhead for a muting pattern is 2⁵·0.0119/5=7.62%. It can be seen that the resource overhead for the muting pattern is exponentially increased as an N value is increased.

If a different interference measurement resource region is configured based on a different serving node set according to UE as described above, there are problems in that muting resource overhead for interference measurement is greatly increased and system resource efficiency is deteriorated.

Now, the present invention will be described.

The result of the existing interference measurement based on the CRS is not proper in the single cell multi node system and the CoMP environment because it is the result of measuring the interference only outside the cell. In order to solve this problem, the method of interference measurement using the zero-power CSI-RS may be used. However, as described above, this method may cause a significantly degradation of the performance due to resource overhead.

The present invention suggests a method of adjusting interference based on network. The method of adjusting interference based on network is a method of adjusting interferences measured based on the reference resource which is used for the interference measurement as much as the value that the network gives an instruction and utilizing it in CSI calculation and reporting when a UE measures interference.

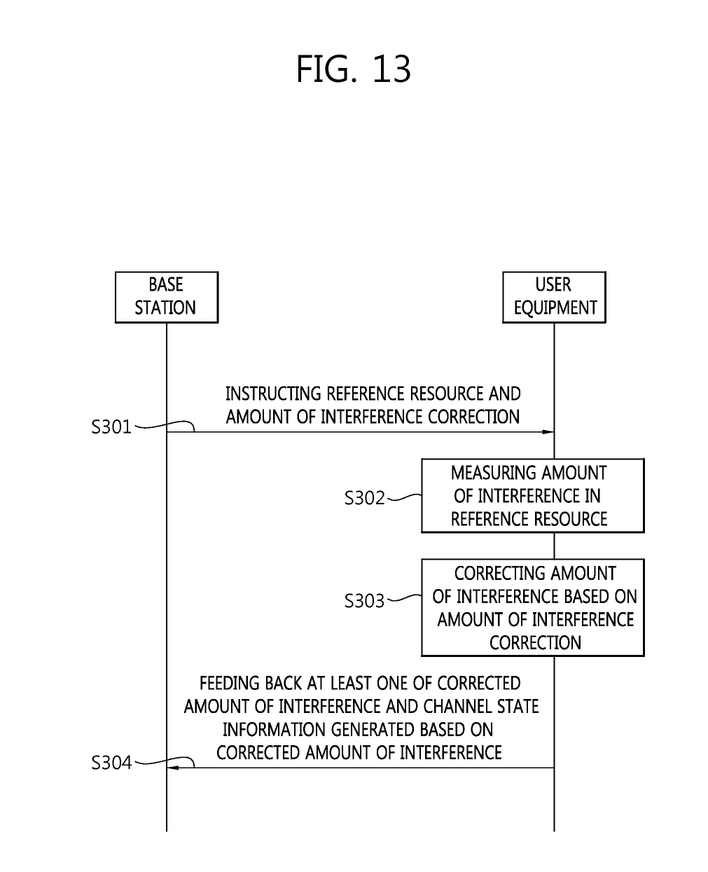

FIG. 13 shows a method of measuring interference according to an embodiment of the present invention.

Referring to FIG. 13, the base station instructs a UE on the reference resource and the amount of interference correction (step, S301). Here, the reference resource means the resource which is an object for the measurement of interference. As an example, the muting patterns shown in FIG. 12 may be a reference resource. That is, the reference resource may be the resource of which multiple nodes transmit the zero-power channel state information.

The UE measures the amount of interference in the reference resource (step, S302).

After the UE compensates the above amount of interference measured based on the amount of interference correction (step, S303), the UE gives feedback at least one of the corrected amount of interference and the channel state information generated based on the corrected amount of interference such as channel quality indicator (CQI) and carrier to interference plus noise ratio (CINR) (step, S304) to the base station.

For example, in case that the method of measuring interference based on the zero-power CSI-RS is introduced in a wireless communication system, the number of the muting pattern which is supported by the base station may be limited in order to decrease the resource overhead.

In this case, the UE having the serving node set that corresponds to the muting pattern which is not supported by the base station should adjust the amount of interference. For example, it is assumed that nodes A, B and C support only one muting pattern (104 in FIG. 12) that corresponds to the serving node set (A, B and C).

In the system, since the interference measurement resource has only one muting pattern (104 in FIG. 12), even the UE whose serving node set is {A, B} may measure the interference (amount of reference interference I) from different nodes excluding notes A, B and C in the muting pattern (104 in FIG. 12). The above muting pattern (104 in FIG. 12) becomes the reference resource. However, there is a problem that the amount of interference (corrected amount of interference J) from node C that actually gives interference to the UE is not included in the reference amount of interference I. In other words, when the reference resource is the resource of which multiple nodes transmit the zero-power channel state information, in case that the interference node except the serving node that is going to receive data by the UE is included in the multiple nodes, the amount of interference correction represents the amount of interference between the UE and the interference node.

In this case, according to the present invention, the base station estimates the amount of interference which is given to the UE on node C (the corrected amount of interference J) and notifies it to the UE and the UE is able to control to add the corrected amount of interference J to the reference interference I. That is, the present invention enables to measure the accurate interference by correcting the discordance between the muting pattern provided by the base station and the serving node set of the UE.

As another example, assuming that the UE receives the CoMP joint transmission (JT) from the serving cell and the cooperative cell. In this case, there is a problem that the interference owing to the signal from the cooperative cell is included in the amount of interference measured based on the CRS of the serving cell (which is referred to reference interferences I). In order to solve the problem, the present invention estimates the amount of interference that the cooperative cell influences on the UE (the corrected amount of interference J) in the network and notifies it to the UE. In network, the amount of interference between the cooperative cell and the UE (the corrected amount of interference J) may be estimated by using the intensity of the uplink signal of the UE and/or the feedback information of the UE. The UE may give feedback of the result of subtracting the corrected amount of interference J from the reference amount of interference I.

In the examples described above, the corrected amount of interference may be either positive or negative. In case of the corrected amount of interference being positive, it corresponds to add the corrected amount of interference to the reference amount of interference, and in case of the corrected amount of interference being negative, it corresponds to subtract the corrected amount of interference from the reference amount of interference.

Although the value of the corrected amount of interference may be signaled, it may also be signaled with the index form representing the value. Let the index be called interference correction index. Table 6 below is an example of representing the relationship between the corrected amount of interference and the interference correction index.

TABLE 6

| Interference | Amount of interference |
|---|---|
| correction index | correction (dB) |
| 0 | −2 |
| 1 | −1 |
| 2 | 1 |
| 3 | 2 |

The interference correction index may be included in the downlink control information (DCI) or the uplink control information (UCI) which is the physical layer control information, or may be included in the RRC message which is the higher layer control information.

The present invention may be used for correcting the amount of interference among different CoMP methods as well as for correcting the discrepancy of the serving node set.

For example, when various transmission techniques such as DPS, JP, CS/CB and the like are applied to the UE that receives the CoMP transmission from two nodes, the corresponding interference may be different. In this case, according to the present invention, the base station may differently determine the corrected amount of interference with regard to the reference amount of interference depending on which CoMP technique is applied and notify it to the UE. The amount of interference correction may be determined according to the cooperative transmission technique which is applied to the reference resource. Accordingly, the UE may correct the amount of interference which is different according to the CoMP transmission technique.

Assuming that N nodes are designated in the CoMP set and the N non zero-power CSI-RS resources are transmitted from each node are set to the UE, the UE is to give a feedback by calculating the CSI for each non zero-power CSI-RS resource. In this time, if the UE is not able to know which CoMP transmission technique is applied by the base station, when calculating the CSI with regard to the each non zero-power CSI-RS resource, there occurs such an ambiguity that whether you suppose that different non zero-power CSI-RS resource in the CoMP set to be interferences, and if doing so, how much amount of interference should be reflected.

This is because, if the DPS is performed, then it is preferable to suppose the non zero-power CSI-RS of different nodes to be interference, but if the DPS is performed but dynamic blanking is performed by different nodes, then it should not be supposed to be interference. The dynamic blanking signifies the way that the signal is turned off in the corresponding resource.

If the CB is applied, the cooperative node acts as interference, but the amount of interference should be decreased by the CB. Accordingly, the interference amount estimated only by non zero-power CSI-RS of the cooperative node can be inaccurate.

The problem can be solved by applying the present invention. That is, the base station provides the UE with the amount of interference correction resulted from the CoMP transmission technique which is applied to the amount of interference estimated by the UE. The amount of interference correction may not be the corrected value for the amount of interference, but the corrected value for the CSI value (for example, CQI). That is, the amount of interference correction may be the corrected value with regard to the channel state information generated based on the amount of interference measured in the reference resource by the UE.

Considering the CoMP transmission and the multi subcarrier transmission, the CQI value that UE should report may be extended to single node, multiple nodes in a single carrier and multiple carriers. Accordingly, multiple amount of interference correction may be provided for the UE.

If multiple non zero-power CSI-RS are allocated of which CSI reporting should be done by the UE, the base station may be signaling the amount of interference correction which is used for CSI calculation of each non zero-power CSI-RS resource or the amount of CSI correction.

If the influence on the performance by the difference of the amount of interference according to the CoMP transmission technique is insignificant, the base station may be signaling only one of the interference amount (or the CSI correction amount) to the UE by each carrier regardless of the number of carriers.

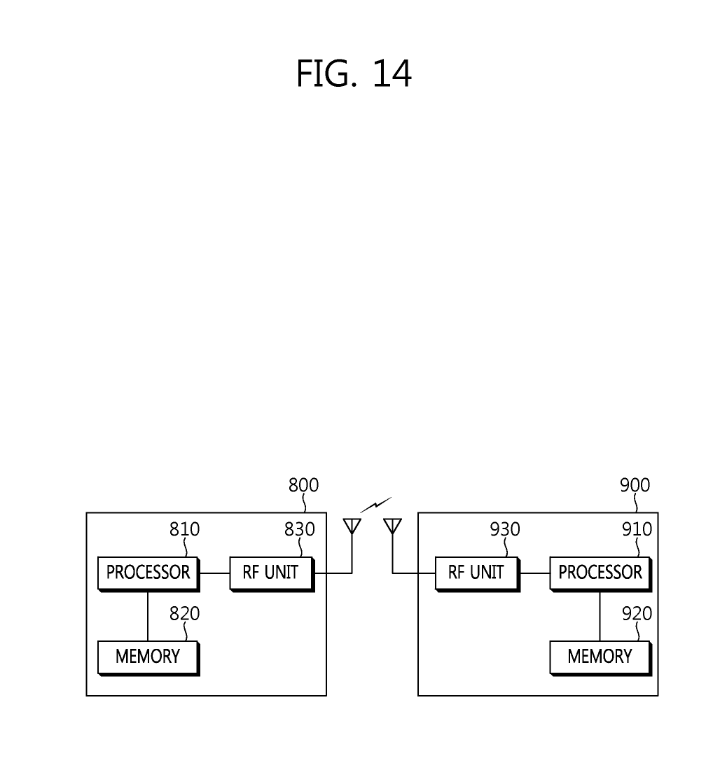

FIG. 14 is a block diagram showing a wireless communication system which an embodiment of the present invention is implemented on.

A BS 800 includes a processor 810, a memory 820, and a radio frequency (RF) unit 830. The processor 810 may be configured to implement proposed functions, procedures, and/or methods in this description. For example, the process 810 may instruct the reference resource and the interference to be corrected to the UE, and receive the feedback of the interferences with regard to the reference resource which is corrected by the corrected amount of interference. This feedback may be used for the later scheduling. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A UE 900 may include a processor 910, a memory 920 and a RF unit 930. The processor 910 may be configured to implement proposed functions, procedures and/or methods described in this description. For example, the processor 910 may receive the reference resource and the corrected amount of interference, and may transmit the corrected amount of interference based on the amount of interference correction after measuring the amount of interference at the reference resource. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

1. A method for measuring interference performed by a user equipment (UE) in a wireless communication system, the method comprising:
receiving instruction of a reference resource and an amount of interference correction;
measuring an amount of interference at the reference resource;
correcting the measured amount of interference based on the amount of interference correction; and
giving feedback at least one of the corrected amount of interference and the channel state information generated based on the corrected amount of interference to the base station.

2. The method of claim 1, wherein the reference resource is the resource of which multiple nodes transmit zero-power channel state information.

3. The method of claim 2, wherein in case that an interference node except a serving node that is going to receive data by the UE is included in the multiple nodes, the amount of interference correction represents the amount of interference between the UE and the interference node.

4. The method of claim 1, wherein the amount of interference correction is an index representing an interference correction value.

5. The method of claim 1, wherein the amount of interference correction is included in a higher layer signal or a physical layer signal.

6. The method of claim 1, wherein the amount of interference correction is determined according to a cooperative transmission technique which is applied to the reference resource.

7. The method of claim 1, wherein the amount of interference correction is a correction value with regard to channel state information generated based on the amount of interference measured in the reference resource.

8. The method of claim 1, wherein in case that the reference resource is multiple, the amount of interference correction is provided for each of the multiple reference resources.

9. A user equipment (UE) to measure interference in a wireless communication system, the UE comprising:
a radio frequency (RF) unit to transmit or receive a wireless communication signal, and
a processor connected to the RF unit,
wherein the processor is configured to perform of:
receiving instruction of a reference resource and an amount of interference correction, measuring an amount of interference at the reference resource, correcting the measured amount of interference based on the amount of interference correction, and giving feedback at least one of the corrected amount of interference and the channel state information generated based on the corrected amount of interference to the base station.
